(19) United States
(12) Patent Application Publication
(10) Pub. No.: US 2008/0217032 A1
(43) Pub. Date: Sep. 11, 2008

(54) Stationary Fire-Fighting System Comprising a Cleaning Device

(75) Inventor: Dirk Sprakel, Koln (DE)

Correspondence Address: BROMBERG & SUNSTEIN LLP, 125 SUMMER STREET, BOSTON, MA, 02110-1618, US

(73) Assignee: FOGTEC BRANDSCHUTZ GMBH & CO. KG, Koln (DE)

(21) Appl. No.: 12/064,312

(22) PCT Filed: Aug. 18, 2006
(86) PCT No.: PCT/EP2006/008155

§ 371 Date: Feb. 20, 2008

(30) Foreign Application Priority Data
Aug. 29, 2005 (DE) 10 2005 040 986.5

(51) Int. Cl. A62C 31/22

(52) U.S. Cl. 169/70

(57) ABSTRACT

The invention relates to a stationary fire-fighting system comprising an extinguisher fluid storage, a pipe between the extinguisher fluid storage and at least one extinguisher fog nozzle, and a high-pressure pump generating a high-pressure in the pipe. In order to put the stationary fire-fighting system to an additional use, it is proposed that cleaning means, which are connected to the pipe by a junction, are provided in such a manner that extinguisher fluid, via the junction in the cleaning means, can be utilized for cleaning surfaces, the high-pressure pump generating a pressure of over 40 bar.

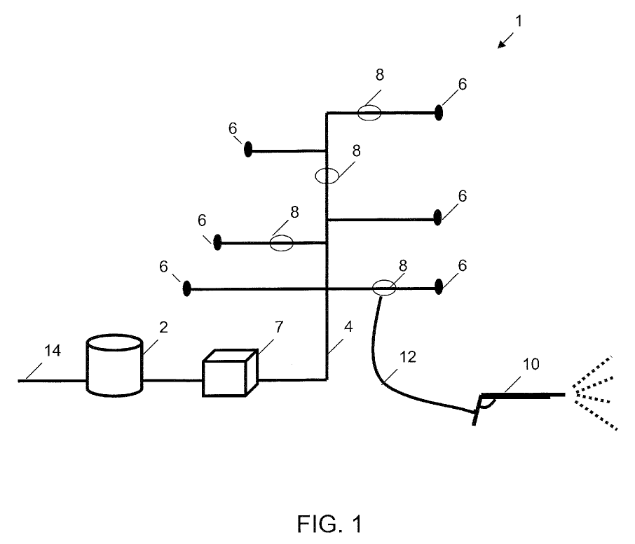

### FIELD OF THE INVENTION

The invention generally relates to a stationary fire-fighting system comprising a fluid storage, a pipe between the fluid storage and at least one extinguisher fog nozzle, and a high-pressure pump generating a high-pressure in the pipe.

### BACKGROUND OF THE INVENTION

With conventional stationary fire-fighting systems the extinguisher fluid storage tank is connected via pipes to extinguisher fog nozzles. The pipes in this case can be preferably widely branched. The pipes, in particular the main pipes, are preferably already charged with extinguisher fluid so that in the event of a fire the extinguisher fluid is quickly available at the extinguisher fog nozzles. A high operating pressure, which in the event of a fire immediately produces very fine atomization of the extinguisher fluid through the extinguisher fog nozzles, is generated in the pipes using modern high-pressure pumps.

Particularly in tunnel installations, for example underground railway installations, road tunnels, etc., high-pressure fire-fighting systems are occasionally used for safety. However, high-pressure fire-fighting systems of the generic kind can be installed in all other building installations.

The investment required for installing stationary fire-fighting systems comprising an extinguisher fluid storage, pipework and high-pressure pump are significant. Pipes have to be laid in the entire building installation to be protected. Due to the high-pressures, the design of the pipe-fittings must be precise. In order to justify the high capital outlay, multi-functional use of the existing pipe systems is desired.

### SUMMARY OF THE INVENTION

Therefore, the object of the invention was to put prior art stationary fire-fighting systems to an additional use. The pay-back of such stationary fire-fighting systems should be increased as a result of their multi-functionality.

This object is achieved according to the invention in that the stationary fire-fighting system has cleaning means, which are connected to the pipe by a junction in such a manner that fluid, via the junction in the cleaning means, can be utilized for cleaning surfaces, the high-pressure pump generating a pressure of over 40 bar.

As a result of deploying high-pressure fire-fighting systems, the extinguisher fluid can be used with cleaning systems as they are applied in industry. In particular, water can be used as the extinguisher fluid. Also, depending on the application, the fluid can be enriched with detergents or other cleaning agents. The cleaning means can be connected to the high-pressure supply and facilitate simple cleaning of surfaces. The stationary fire-fighting systems can thus be put to additional use.

Particularly in road tunnels, but also in railway tunnels, as well as in other building installations, it is necessary to regularly clean walls and markings. In particular, reflective paints are used for identifying escape routes and emergency exits as well as for safety-relevant markings. The markings must be regularly cleaned in order to meet national and building-regulation safety requirements. Since high-pressure fire-fighting systems are being used more and more in building installations, these can also be used according to the invention in routine operation for cleaning the walls and surfaces of the building installations.

Further advantages will become clear from the subordinate claims.

### BRIEF DESCRIPTION OF THE DRAWINGS

The single FIGURE shows a stationary fire-fighting system 1 comprising an extinguisher fluid storage 2, a pipe 4, extinguisher fog nozzles 6, junctions 8, a cleaning gun 10, a connection hose 12 and a supply pipe 14.

### DESCRIPTION OF ILLUSTRATIVE EMBODIMENTS

The extinguisher fluid storage 2 is filled as required via the supply pipe 14. A jockey pump generates a stationary static pressure of the extinguisher fluid in the pipe. The static pressure lies substantially below the operating pressure. This static pressure exists in the pipe 4 irrespective of a fire. The pipe 4 is widely branched and has links to extinguisher fog nozzles 6. Preferably, the main pipes, for example in the longitudinal direction of a tunnel, are pre-charged with extinguisher fluid. Local valves, to which local pipes branching off the main pipes are connected, can join the main pipes. The local pipes can also be pre-charged. The extinguisher fog nozzles 6 are preferably located in safety-critical areas of tunnels. The extinguisher fog nozzles 6 are designed in such a manner that with their aid a very fine fog curtain, which cools the area surrounding the seat of the fire to good effect and thus has a good fire-extinguishing property, can be created in the event of a fire. By means of a high-pressure of more than 40 bar, very fine atomization is achieved for the extinguisher fluid. Because the extinguisher fog nozzles 6 are widely distributed, the pipe 4 is present in most parts of the tunnel.

In order to be able to clean the tunnel, in the area where cleaning is necessary, a junction 8 is provided. The junction 8 can be designed as a plug-in connection, as a result of which a hose 12 can be plugged into the junction 8.

The supply of extinguisher fluid from the pipe 4 to the hose 12 in the junction 8 can be regulated by means of a valve assembly not illustrated in detail. Also, it is possible that the valve assembly is configured in the junction 8 in such a manner that extinguisher fluid can only be fed to the hose 12 if the extinguisher fluid pressure in the pipe 4 does not fall below a lower limit. For cleaning, a pressure of 40 bar and above can be generated. A directional cleaning jet can be produced at the cleaning gun 10 by the high-pressure.

Fires can also be detected with the aid of fire detectors and in the event of a fire being discovered in a branch remote from a junction 8, which is being used, for example, the cleaning gun 10 is prevented from being supplied with extinguisher fluid by a corresponding valve control. This ensures that in the case of a fire the fluid pressure generated by the high-pressure pump 2 is also actually available at the extinguisher fog nozzles 6 and is not reduced as a result of being siphoned off for cleaning.

The hose 12 is preferably designed to withstand high-pressure. The cleaning gun 10 is supplied with extinguisher fluid via the hose 12. A good cleaning result is obtained because of the high-pressure. The cleaning gun 10 can be used to thoroughly clean surfaces.

1-11. (canceled)

12. A stationary fire-fighting system installed in a tunnel, comprising:
a fluid storage tank;
a pipe between the fluid storage tank and at least one extinguisher fog nozzle;
a high-pressure pump generating a high-pressure in the pipe; and
cleaning means, which are connected to the pipe by a junction in such a manner that fluid, via the junction in the cleaning means, can be utilized for cleaning surfaces, the high-pressure pump generating a pressure of over 40 bar.

13. A fire-fighting system according to claim 12, wherein the pipe is a pipe system, which is branched out in the tunnel.

14. A fire-fighting system according to claim 12, wherein the cleaning means is an automatic cleaning machine.

15. A fire-fighting system according to claim 12, wherein the cleaning means is a cleaning gun.

16. A fire-fighting system according to claim 12, wherein the cleaning means has a cleaning nozzle.

17. A fire-fighting system according to claim 12, wherein the cleaning means is connected to the junction by a high-pressure hose.

18. A fire-fighting system according to claim 12, wherein the cleaning means is connected to the junction by a high-pressure coupling.

19. A fire-fighting system according to claim 12, wherein the high-pressure pump generates a fluid pressure of at least 40 bar at the fire-extinguishing nozzle.

20. A fire-fighting system according to claim 12, wherein the high-pressure pump generates a fluid pressure of at least 40 bar at the cleaning means.

21. A fire-fighting system according to claim 12, wherein the droplet size of the fluid leaving the cleaning means is between 10 μm and 2.5 mm.

22. A fire-fighting system according to claim 12, wherein the fluid contains detergents.
